(19) United States
(12) Patent Application Publication
(10) Pub. No.: US 2004/0227926 A1
(43) Pub. Date: Nov. 18, 2004

(54) Receiving module

(76) Inventors: Chieh-Jen Lee, Tanzih Township (TW); Shu-Hung Lin, Taichung (TW); Jung-Hong Chen, Tanzih Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/846,767

(22) Filed: May 14, 2004

(30) Foreign Application Priority Data
May 15, 2003 (TW) 92113170

(51) Int. Cl. G01C 3/08

(52) U.S. Cl. 356/4.01; 356/5.01

(57) ABSTRACT

A receiving module applied in a rangefinder. The receiving module, receiving beams of different incident angles, includes a light pipe having a receiving end, an emitting end and a reflecting surface connecting the receiving end and the emitting end. The light pipe also has an optical axis perpendicular to the receiving and the emitting ends. When beams of different incident angles from different positions enter the light pipe, the light pipe confines the beams to a certain area. Using the receiving module of the invention, the rangefinder can measure targets from all ranges.

### BACKGROUND OF THE INVENTION

1. Field of the Invention

This invention relates to a receiving module, and more particularly, to a receiving module applied in a rangefinder.

2. Description of the Related Art

FIG. 1 schematically shows a conventional optical rangefinder, disclosed in U.S. Pat. No. 6,441,887. The optical rangefinder 1 includes an emitter 2, a telescopic system 3 and a receiving system 4. Referring to FIG. 1, a beam from the emitter 2 passes through the telescopic system 3, incident on the target. Next, a beam reflected by the target enters the receiving system 4.

FIG. 2A schematically shows the rangefinder of FIG. 1, measuring a target at 100 m, and FIG. 2B schematically shows the rangefinder of FIG. 1, measuring a target at 1 m. Referring to FIGS. 1 and 2A, the interval between the receiving system 4 and the telescopic system is about 7 cm, and the distance from target T to the optical rangefinder 1 is around 100 m. The receiving system 4, target T, and telescopic system 3 form an included angle θ1. The included angle 31 is around 0.0007 radians. Referring to FIGS. 1 and 2B, the receiving system 4, target T, and telescopic system 3 form another included angle θ2. The included angle θ2 is around 0.07 radians.

However, when the included angle increases from 0.0007 radians to 0.07 radians, the reflected beam Br2 from the target T has difficulty entering the receiving system 4. In general, by increasing the diameter of the receiving system, the reflected beam Br2 enters the receiving system 4 easily. However, the reflected beam Br2 cannot be received by the light sensor even though the reflected beam Br2 enters the receiving system 4.

In addition, the U.S. Pat. No. 5,815,251 discloses another range finder using many ways to receive the reflecting beam. However, the complex mechanism is difficult to execute.

### SUMMARY OF THE INVENTION

To solve the above problems, it is an object of the present invention to provide a receiving module applied in a rangefinder for measuring short range and long distances.

According to the object of the invention, the receiving module includes an object lens, a light pipe and a light sensor. The object lens has an optical axis, and the light pipe has a receiving end, an emitting end and a reflecting surface, respectively connected the receiving and emitting ends. After a beam, not parallel to the optical axis, passes the object lens, the object lens alters the beam to approximately parallel to the optical axis. Next, the beam enters the light pipe via the receiving end and is reflected several times by the reflecting surface. The beam from the emitting end of the light pipe converges on one area, in which the light sensor is located.

The receiving module of the invention is applied in an optical rangefinder, further comprising an emitter and another object lens.

The light pipe comprises a plurality of mirrors, or can comprise a solid rod with a reflecting surface is coated with a reflecting film. When a beam enters the light pipe, the beam is reflected by the reflecting surface and leaves the light pipe from the emitting end.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 schematically shows a conventional optical rangefinder as disclosed in U.S. Pat. No. 6,441,887;

FIG. 2A schematically shows the optical rangefinder of FIG. 1, measuring a target at 100 m;

FIG. 2B schematically shows the optical rangefinder of FIG. 1, measuring a target at 1 m;

FIG. 3 schematically shows beams entering an object lens at different angles;

FIG. 4 schematically shows a light pipe guiding beams to a convergence area;

FIG. 5A schematically shows a receiving module of the invention;

FIG. 5B schematically shows another receiving module of the invention;

FIG. 5C schematically shows another receiving module of the invention;

FIG. 6A schematically shows a rangefinder utilizing the receiving module of the invention;

FIG. 6B schematically shows another rangefinder utilizing the receiving module of the invention; and

FIGS. 7A to 7C schematically show all different light pipe types.

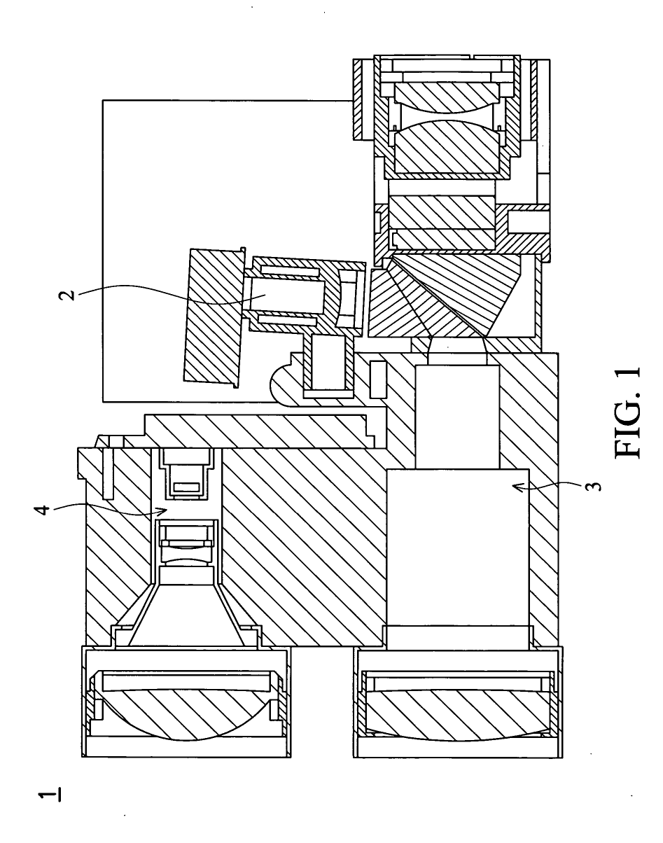

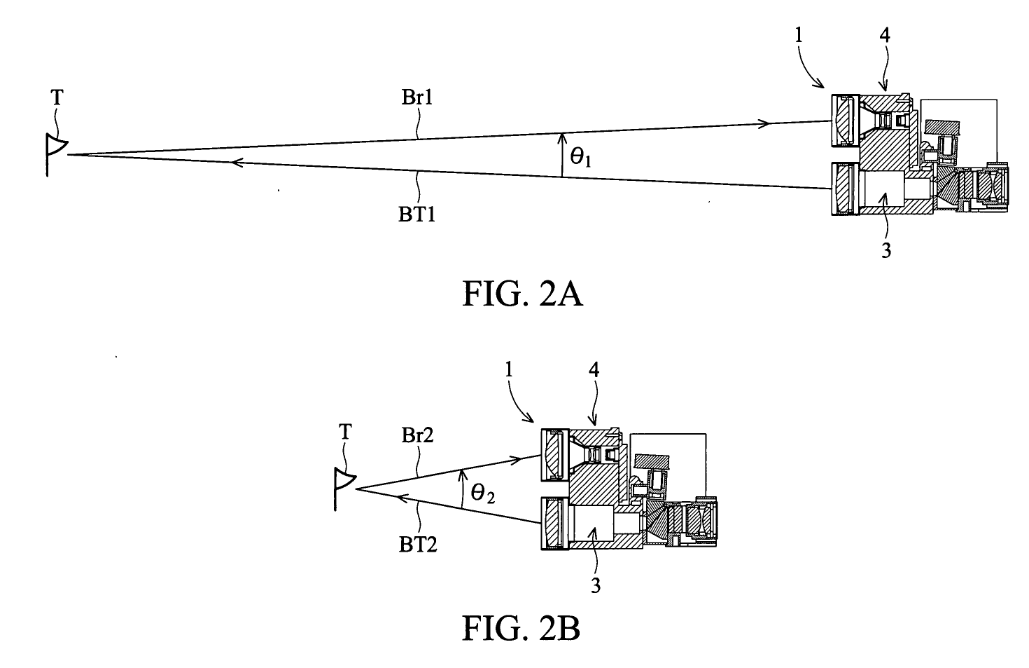

### DETAILED DESCRIPTION OF THE INVENTION

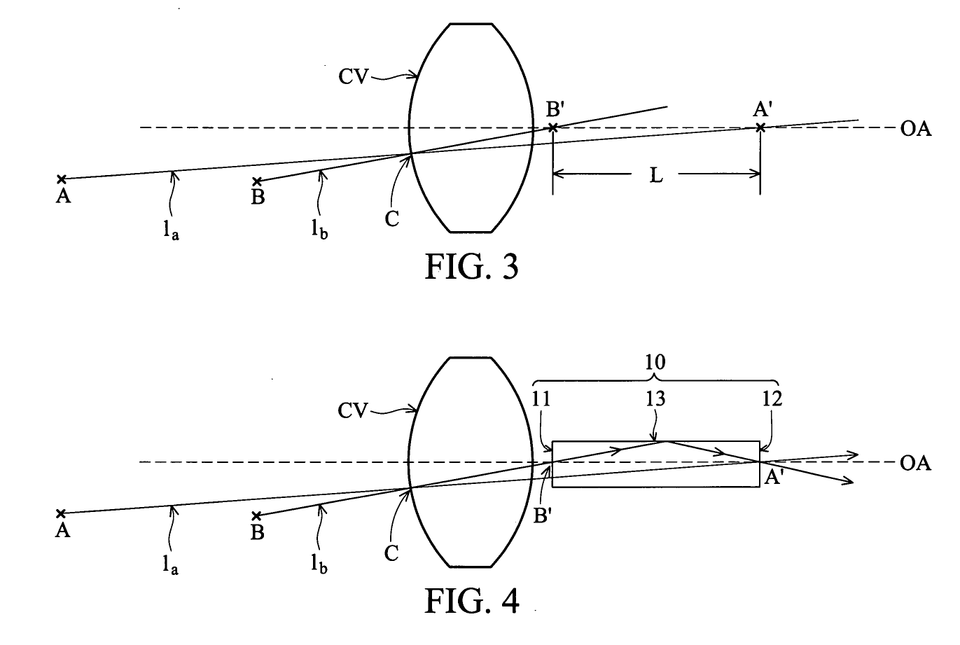

FIG. 3 schematically shows beams entering an object lens at different angles. As shown in FIG. 3, the distance between point A and the positive lens CV exceeds the distance between point B and the positive lens CV, with the incident angle of the beam 1a from point A to the positive lens CV less than the incident angle of the beam 1b from point B to the positive lens CV. According to Snell's law, the beam 1a travels through the positive lens CV and reaches a point A′ of an optical axis OA of the positive lens CV, and the beam 1b travels through the positive lens CV and reaches a point B′ of an optical axis OA of the positive lens CV. Thus, beams from different light source reach different points by passing the positive lens CV. The distance between points A′ and B′ is represented as L.

FIG. 4 schematically shows a light pipe guiding beams to a convergence area. Referring to FIG. 4, the light pipe 10 has a length L, and a receiving end 11, emitting end 12, and enclosed reflecting surface 13, connecting the receiving end 11 and the emitting end 12. In the invention, the receiving end 11 of the light pipe 10 is located at point B′, and the emitting end 12 point A′. The optical axes of light pipe 10 and positive lens CV are coaxial.

As shown in FIG. 4, the beam 1a from point A passes the positive lens CV according to Snell's law, and the beam 1a enters the light pipe 10 via the receiving end 11. Next, the beam 1a from point A intersects the optical axis OA at point A′.

As shown in FIG. 4 the beam 1b from point B passes the positive lens CV according to Snell's law, and intersects the optical axis OA at point B′. The point B′ is located on the receiving end 11, such that beam 1b from point B is reflected by the reflecting surface 13 and travels forward in light pipe 10. Thus, according to the light tracing shown in FIG. 4, the beam 1b from point B intersects the optical axis OA at point A′ again. Beams emitted from different positions pass the positive lens CV and travel forward in light pipe 10, and then intersect the optical axis OA in substantially the same position.

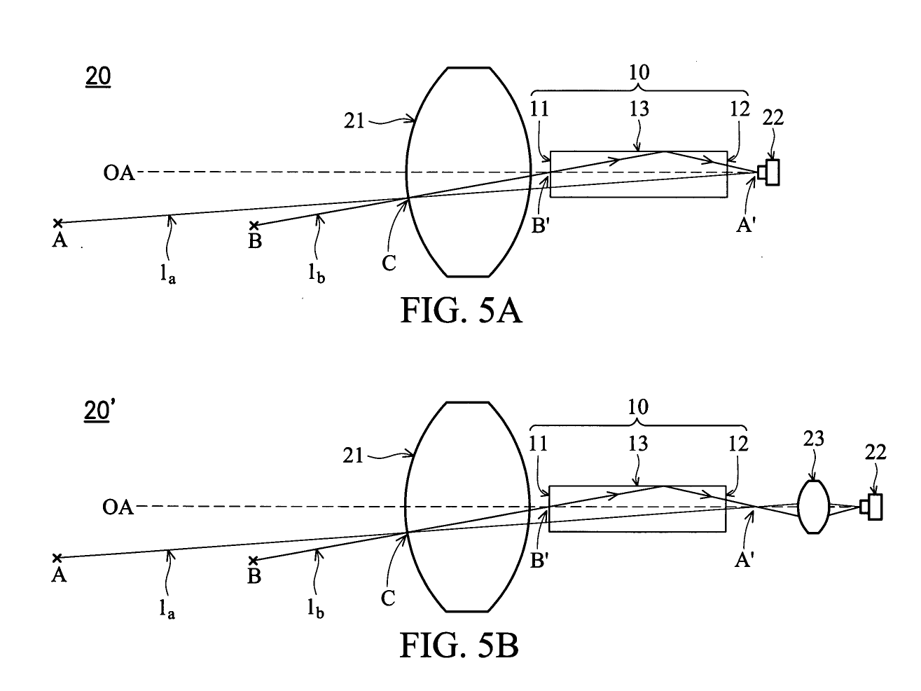

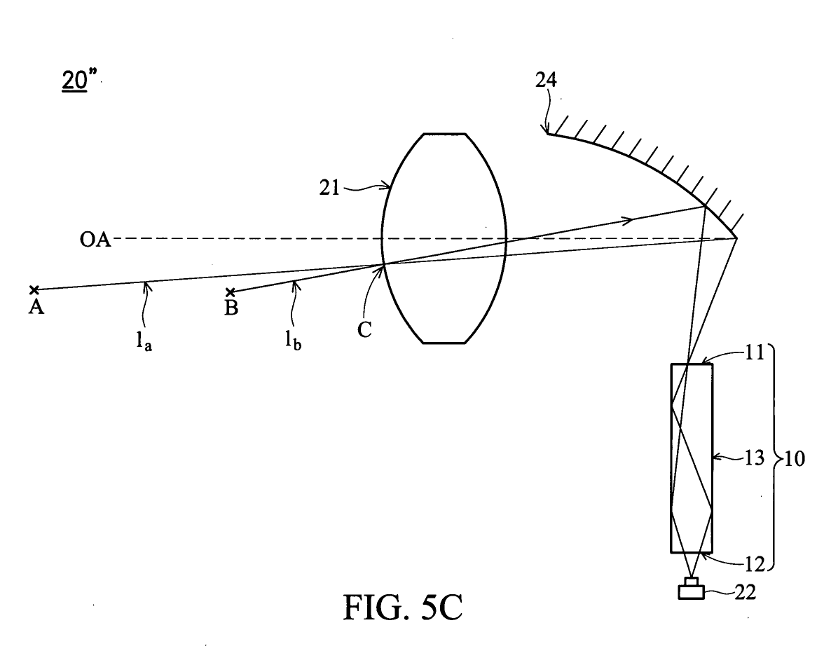

FIG. 5A schematically shows a receiving module of the invention. As shown in FIG. 5A, the receiving module 20 of the invention includes a positive lens 21, a light pipe 10 and a detector 22, wherein the positive lens 21 and the light pipe 10 have the same optical axis OA. When two different beams 1a, 1b travel through the positive lens 21 and the light pipe 10, the beams 1a, 1b respectively intersect the optical axis OA at two neighboring points, forming an area A′. The detector 22 is located in area A′ to receive beams 1a, 1b from different light sources. Referring to FIG. 5A, the light pipe 10 confines the beams from different light sources to the area A′, smaller than the area of the detector for receiving the beams. FIG. 5B schematically shows another receiving module of the invention. As shown in FIG. 5B, the receiving module 20′ further includes an aspherical lens 23 located near the emitting end 13 of the light pipe 10, to reduce area A′, ensuring that detector 22 receives the beams from all ranges. Referring to FIG. 5B, the aspherical lens 23 confines beams from different light source to the area, smaller than area A′ and the area of the detector for receiving the beams. FIG. 5C schematically shows another receiving module of the invention. As shown in FIG. 5C, the receiving module 20″ further includes a concave mirror 24, by which the beams 1a, 1b passing the positive lens are reflected. The reflected beams 1a, 1b enter the light pipe 10 via the receiving end 11 and propagate forward by reflection in the light pipe 10. Next, beams 1a, 1b from the emitting end 12 of the light pipe 10 are received by detector 22. In this invention, the surface of the concave mirror is preferably aspherical, and beams from the light pipe 10 can be further confined to a smaller area, ensuring that detector 22 receives the beams from all ranges.

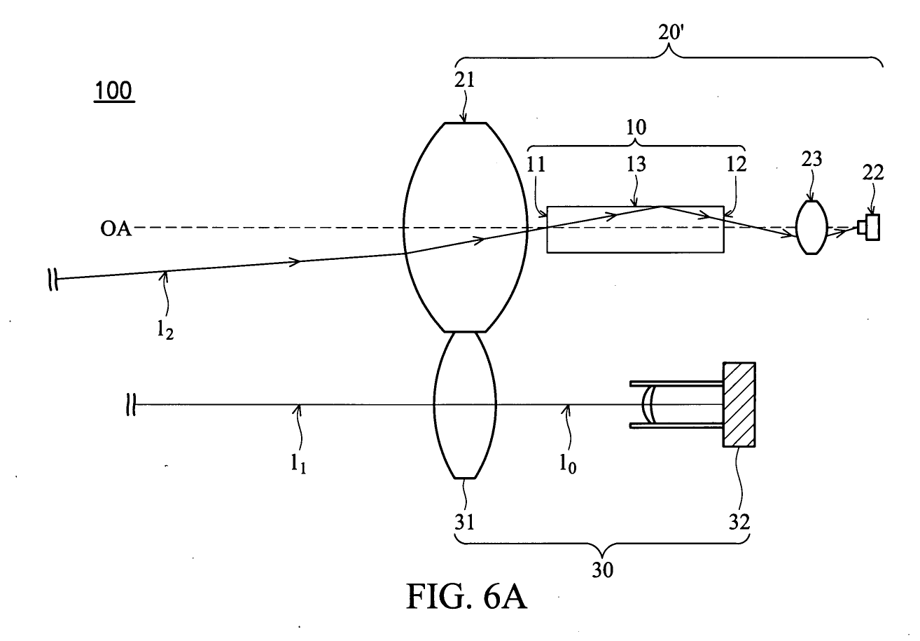

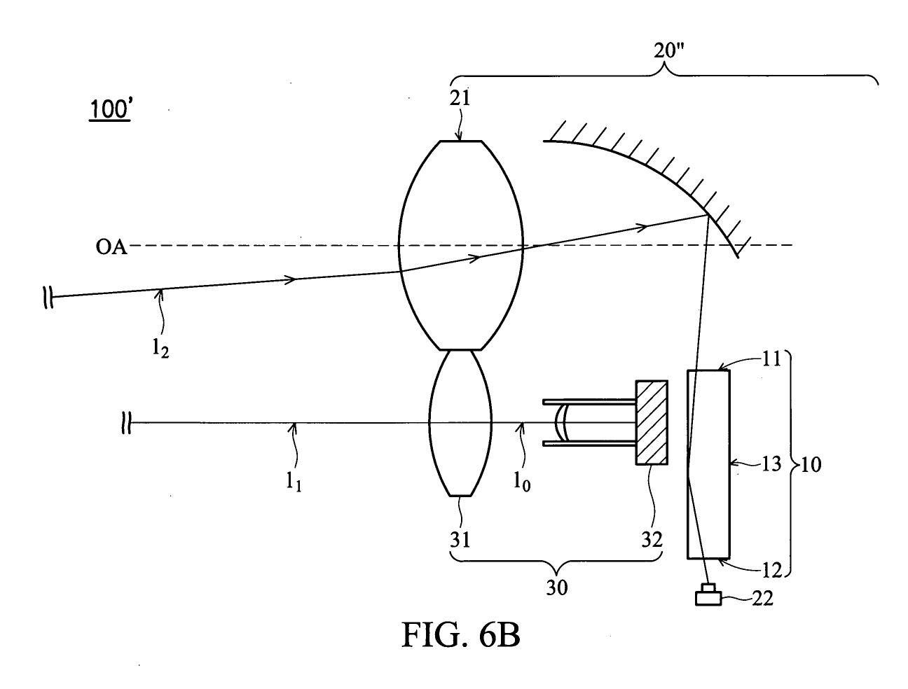

FIG. 6A schematically shows a rangefinder utilizing the receiving module of the invention shown in FIG. 5B. As shown in FIG. 6A, the optical system of the rangefinder 100 includes an emitting module 30 and receiving module 20′. The emitting module 30 includes an emitting device 32 and a collimating lens 31. After the emitting device 32 emits a beam of narrow-band 1₀, the beam of narrow-band 1₀ is converted to form a collimated beam 1₁ by passing the collimating lens 31. The collimated beam 1₁ is incident on a target (not shown), and reflected thereby to form a reflected collimated beam 1₂. A portion of reflected beam 1₂ enters the receiving module 20′ via the positive lens 21. No matter the distance to the target, the reflected beam 1₂ from the target is confined to one area by the light pipe 10. Next, the area is reduced by an aspherical lens 23, and the detector 22 receives the reflected beam 1₂. FIG. 6B schematically shows another rangefinder utilizing the receiving module shown in FIG. 5C. As shown in FIG. 6B, the optical system of the rangefinder 100′ includes an emitting module 30 and the receiving module 20″. The emitting module 30 includes an emitting device 32 and the collimating lens 31. The emitting device 32 emits a beam of narrow-band 1₀, which is then converted to collimated beam 1₁ by passing the collimating lens 31, and is incident on a target (not shown), and reflected thereby to form a reflected collimated beam 1₂. A portion of reflected beam 1₂ enters the receiving module 20″ via the positive lens 21. No matter the distance to the target, the reflected beam 1₂ from the target is confined to one area by the concave mirror 24 and the light pipe 10. The area can be further reduced by an aspherical lens, with the detector 22 receiving the reflected beam 1₂.

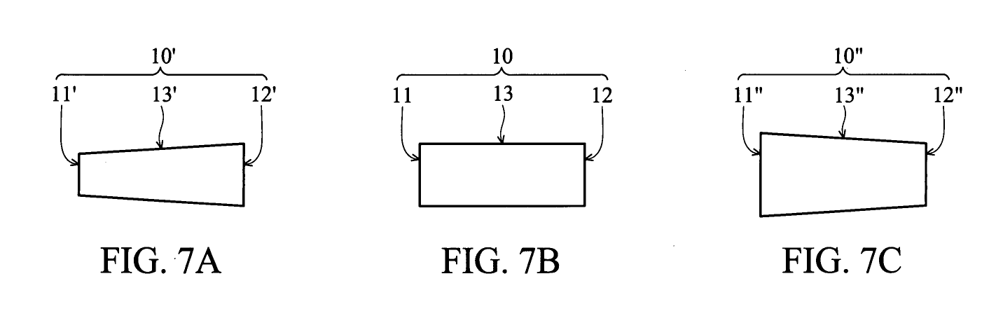

FIGS. 7A to 7C schematically show a variety of light pipes. As shown in FIG. 7A, the area of the receiving end 11′ of the light pipe 10′ is smaller then the area of the emitting end 12′. As shown in FIG. 7B, the area of the receiving end 11 of the light pipe 10 is equal to the area of the emitting end 12′. As shown in FIG. 7C, the area of the receiving end 11″ of the light pipe 10″ is larger then the area of the emitting end 12″. In the invention, the light pipe can be a solid rod with a reflecting surface coated with a reflecting film. In addition, the light pipe can be a hollow rod and comprises a plurality of mirrors.

The receiving module of the invention receives beams of different incident angle, for confinement beams to an area not larger than the area of the detector. Thus, the detector receives the beams from different positions.

No matter the distance to the target, the receiving module of the invention applied to the rangefinder receives reflected beams, assuring measurement of distance to the target.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A receiving module, receiving beams of different incident angles, comprising:
a positive lens comprising an optical axis, the beams intersecting the optical axis in a first position after passing through the positive lens;
a light pipe comprising a receiving end, an emitting end and a reflecting surface connecting the receiving end and the emitting end, wherein beams from the first position enter the light pipe via the receiving end and depart from the emitting end, confined to one area in a second position; and
a detector positioned in the second position to receive the beams.

2. The receiving module as claimed in claim 1, wherein the area of the receiving end of the light pipe is equal to the area of the emitting end.

3. The receiving module as claimed in claim 1, wherein the area of the receiving end of the light pipe exceeds the area of the emitting end.

4. The receiving module as claimed in claim 1, wherein the area of the receiving end of the light pipe is smaller than the area of the emitting end.

5. The receiving module as claimed in claim 1, further comprising a concave mirror reflecting the beams from the positive lens to the receiving end of the light pipe.

6. A receiving module, receiving beam with different incident angles, comprising:
a positive lens comprising an optical axis, the beams intersecting the optical axis in a first position after passing through the positive lens;
a light pipe comprising a receiving end, an emitting end and a reflecting surface connecting the receiving end and the emitting end, wherein the beams from the first position enter the light pipe via the receiving end and depart from the emitting end, confined to a first area in a second position;
an aspherical lens adapted to confine the beam from the light pipe to a second area in a third position; and
a detector positioned in the third position to receive the beams.

7. The receiving module as claimed in claim 6, wherein the area of the receiving end of the light pipe is equal to the area of the emitting end.

8. The receiving module as claimed in claim 6, wherein the area of the receiving end of the light pipe exceeds the area of the emitting end.

9. The receiving module as claimed in claim 6, wherein the area of the receiving end of the light pipe is smaller than the area of the emitting end.

10. The receiving module as claimed in claim 6, further comprising a concave mirror reflecting the beams from the positive lens to the receiving end of the light pipe.

11. A rangefinder measuring the distance between the rangefinder and a target, comprising:
an emitting module, comprising:
an emitting device, emitting a narrow-band beam; and
a collimating lens, collimating the beam to propagate to the target; and
a receiving module, receiving beams of different incident angles, comprising:
a positive lens comprising an optical axis, the beams intersecting the optical axis in a first position after passing through the positive lens;
a light pipe comprising a receiving end, an emitting end and a reflecting surface connecting the receiving end and the emitting end, wherein the beams from the first position enter the light pipe via the receiving end and depart from the emitting end, confined to one area in a second position; and
a detector positioned in the second position to receive the beams.

12. The receiving module as claimed in claim 11, wherein the area of the receiving end of the light pipe is equal to the area of the emitting end.

13. The receiving module as claimed in claim 11, wherein the area of the receiving end of the light pipe exceeds the area of the emitting end.

14. The receiving module as claimed in claim 11, wherein the area of the receiving end of the light pipe is smaller than the area of the emitting end.

15. The receiving module as claimed in claim 11, further comprising a concave mirror reflecting the beams from the positive lens to the receiving end of the light pipe.

16. A rangefinder measuring the distance between the rangefinder and a target, comprising:
an emitting module, comprising:
an emitting device, emitting a narrow-band beam; and
a collimating lens, collimating the beam to propagate to the target; and
a receiving module, receiving beams of different incident angles, comprising:
a positive lens comprising an optical axis, the beams intersecting the optical axis in a first position after passing through the positive lens;
a light pipe comprising a receiving end, an emitting end and a reflecting surface connecting the receiving end and the emitting end, wherein the beams from the first position enter the light pipe via the receiving end and depart from the emitting end, confined to a first area in a second position;
an aspherical lens adapted to confine the beam from the light pipe to a second area in a third position; and
a detector positioned in the third position to receive the beams.

17. The receiving module as claimed in claim 16, wherein the area of the receiving end of the light pipe is equal to the area of the emitting end.

18. The receiving module as claimed in claim 16, wherein the area of the receiving end of the light pipe exceeds the area of the emitting end.

19. The receiving module as claimed in claim 16, wherein the area of the receiving end of the light pipe is smaller than the area of the emitting end.

20. The receiving module as claimed in claim 16, further comprising a concave mirror for reflecting the beams from the positive lens to the receiving end of the light pipe.
